(19) United States
(12) Patent Application Publication
(10) Pub. No.: US 2009/0101591 A1
(43) Pub. Date: Apr. 23, 2009

(54) STORM DRAIN INLET PROTECTION DEVICE

(76) Inventor: Clinton Lewis, Labadie, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 12/257,162

(22) Filed: Oct. 23, 2008

Related U.S. Application Data
(60) Provisional application No. 60/982,026, filed on Oct. 23, 2007.

(51) Int. Cl. E03F 5/16; C02F 1/00; C02F 103/06

(52) U.S. Cl. 210/747; 210/163

(57) ABSTRACT

A reusable protection device for a storm drain inlet includes a semi-permeable sleeve filled with a filter media. The protection device generally seats over a mouth to cover the storm drain inlet to allow passage of water runoff, but limit passage of sediment into the storm drain inlet. The sediment can be removed with a cleaning process for the removal of additional sediment from additional runoff water.

### CROSS-REFERENCE TO RELATED APPLICATIONS

This application is related to U.S. Provisional Patent Application No. 60/982,026 filed Oct. 23, 2007 from which priority is claimed, and is hereby incorporated by reference.

### STATEMENT REGARDING FEDERALLY SPONSORED RESEARCH

Not Applicable.

### BACKGROUND OF THE INVENTION

This invention relates, in general, to storm drain protection, and more particularly, to storm drain inlet protection.

Generally, storm drain systems collect rain and ground water from paved streets, parking lots, sidewalks, and other areas, and divert the water into natural waterways, such as creeks, rivers, stream channels, lakes, and oceans. The purpose of such a system is to reduce drainage related surface damage from water runoff and prevent flooding of streets, highways, and other areas.

Typically, storm drain systems include a series of inlets with catch basins connected by drainpipes to outlets that discharge the water into the natural waterways. Storm drain systems are usually separate from a sanitary sewer system, which collects household wastewater from toilets, showers and sinks. Wastewater from sanitary sewer systems is sent to a facility where it is first treated before discharging to a waterway. In contrast, storm water from storm drain systems is not usually treated and may carry sediment, debris, and contaminants directly into waterways. In addition, the sediment, debris and contaminants can clog and pollute the storm drain system.

Storm drain systems in newly developed areas are primarily constructed by developers as a condition of development. Storm drains are usually operational before work on the construction site is completed. During construction, water runoff from construction sites can carry large amounts of sediment and debris. To reduce clogging and pollution of storm drain systems, many communities have established design guidelines for developers to follow during construction. Frequently, the guidelines require the developers to take precautionary measures during construction to prevent sediment and debris in the water runoff from entering the storm drain system.

Typically, developers employ various protection devices, such as the one disclosed in U.S. patent application Ser. No. 11/542,433 and hereby incorporated by reference, that attempt to block or filter the sediment and debris often found in water runoff from entering the storm drain inlets. However, these devices are difficult to install and transport, and are not reusable.

Therefore, there is a long-felt need for a reusable and environmentally friendly protection device for storm drain inlets that limits sediment from entering storm drain inlets and allows for easy installation and transport.

### DESCRIPTION OF THE DRAWINGS

In the accompanying drawings which form part of the specification;

FIG. 1 is a perspective view of a storm drain inlet;

FIG. 2 is a cross-section view of a protection device installed on the storm drain inlet of FIG. 1;

FIG. 3 is a perspective view of an alternate storm drain inlet;

FIG. 4 is a perspective view of the protection device installed on the alternate storm drain inlet of FIG. 3; and

FIG. 5 is a cross-section view of the protection device installed on the alternate storm drain inlet of FIG. 3.

Corresponding reference numerals indicate corresponding parts throughout the several figures of the drawings.

### DETAILED DESCRIPTION

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

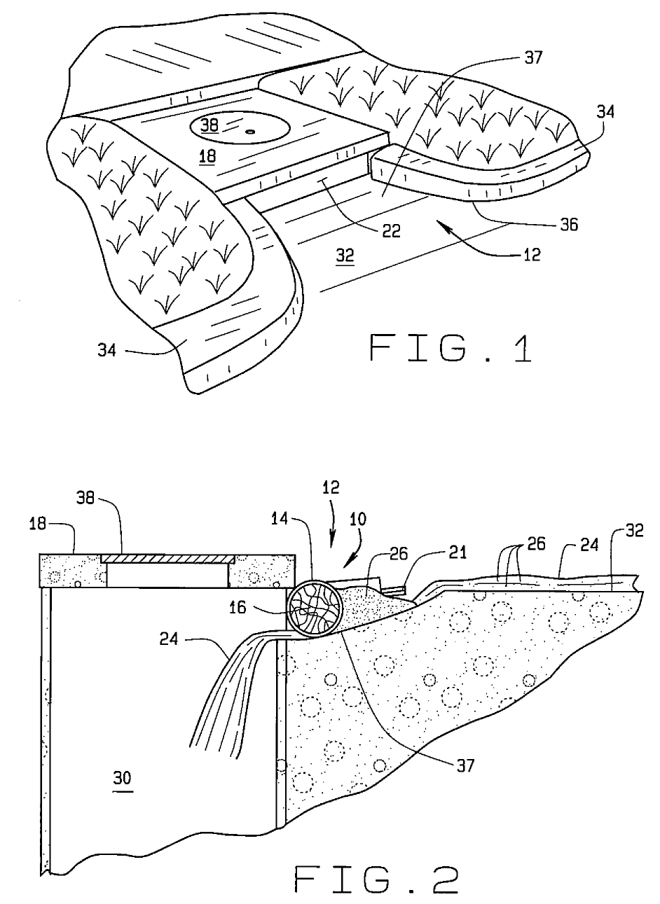

As shown in FIGS. 2-5, an embodiment of the present invention, generally referred to as a reusable protection device 10 for a storm drain inlet 12, includes a non-biodegradable semi-permeable sleeve 14 filled with a non-biodegradable filter media 16. The protection device 10 generally seats over a mouth 22 to cover the storm drain inlet 12 to allow passage of water runoff 24, but limit passage of sediment 26 into the storm drain inlet 12.

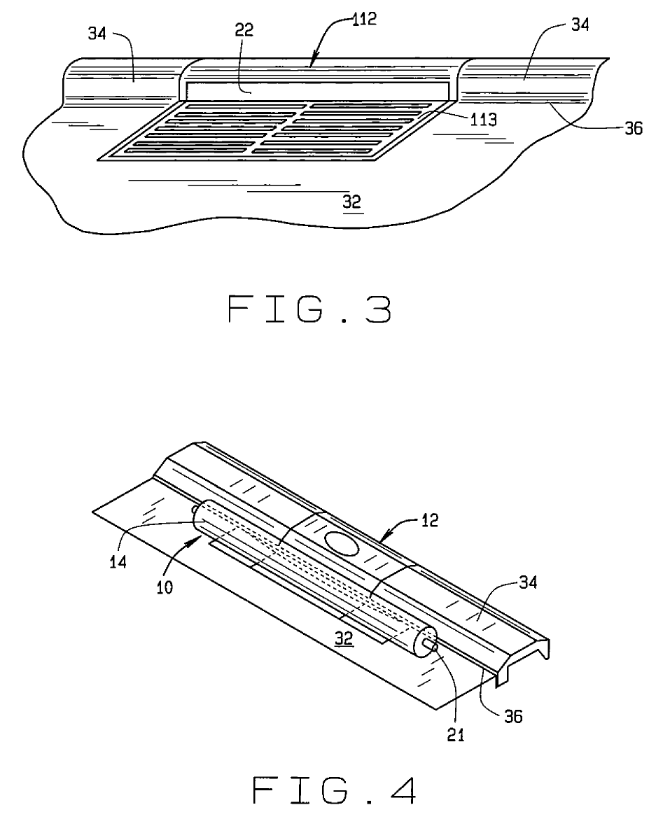

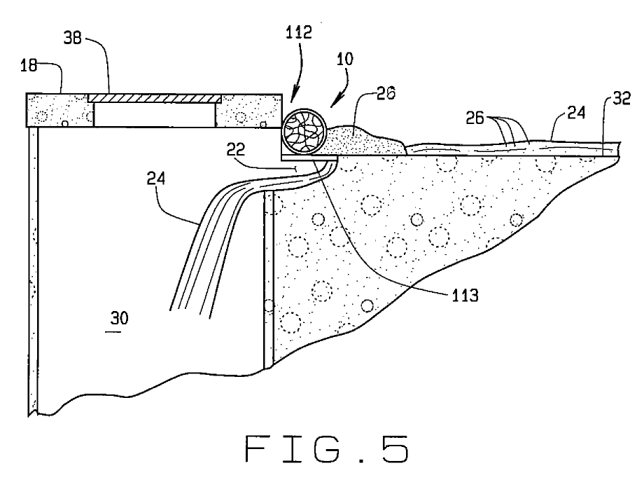

The storm drain inlet 12 includes a generally underground catch basin 30 (FIGS. 2 and 5) associated with a roadway 32 and curb 34 (FIG. 1). The catch basin 30 defines the mouth 22 positioned at an intersection of the roadway 32 and curb 34 for receiving water runoff 24, which is conveyed to the mouth 22 through gutters 36 (FIGS. 1 and 3). In the embodiment of FIGS. 1-2, the roadway 32 includes a sloped portion 37 to further aid and direct the water runoff 24 into the mouth 22. An upper section 18 of the catch basin 30 includes a removeable manhole cover 38 that can be removed to provide access to the catch basin 30. Those skilled in the art will recognize that the protection device can engage with many other embodiments of the storm drain inlet. For example, FIGS. 3-5 illustrate an alternate storm drain inlet 112, which includes a grate 113.

The sleeve 14 is generally tubular with each end closed with an appropriate closure member 21, such as a cord, wire, string, stitches, plug, weld, and the like (FIGS. 2, 4-5). The sleeve 14 is made from a non-biodegradable semi-permeable material that generally allows passage of water runoff 24, but substantially limits passage of sediment 26. The semi-permeable material is preferably a geotextile material, such as synthetic polymer. However, any semi-permeable material can be used, such as woven or nonwoven fabrics, synthetic and non-synthetic materials, and the like.

The filter media 16 is comprised of pieces or fragments of chopped or shredded tire (FIGS. 2 and 5). The filter media 16 within the sleeve allows passage of water runoff 24, but substantially limits passage of sediment 26. Preferably, the pieces of filter media 16 vary in size from about 0.125″ to about 1″ and the shape of the filter pieces 16 are non-uniform. However, those skilled in the art will recognize that the size and shape of the filter media 16 can be varied according to the application and the degree of filtration desired. Further, the filter media can be made from materials other than chopped or shredded tires.

In operation, the protection device 10 seats over the mouth 22 to cover the storm drain inlet 12 (FIG. 2). In this position, the protection device 10 acts as a filter that removes the sediment 26 from the runoff water 24 and traps the sediment 26 within the sleeve 20 and filter media 16, while permitting runoff water 24 to enter the basin 30.

Similarly, the protection device 10 is placed over the mouth 22 and grate 113 to cover the alternate storm drain inlet 112 (FIGS. 4-5). In the same way as the storm drain inlet 12, the protection device 10 acts as a filter that removes the sediment 26 from the runoff water 24 and traps the sediment 26 within the sleeve 20 and filter media 16, while permitting runoff water 24 to enter the basin 30.

Due to the filter media 16 being made from chopped or shredded rubber tires and the sleeve from a synthetic polymer, the protection device 10 can be washed and reused many times. While the flow of runoff water 24 through the protection device 10 traps sediment 26 within the filter media 16, the sediment 26 can be removed with an appropriate cleaning process, including but not limited to, washing, agitation, cleaning solutions, and the like. Because of the protection device's capability of being reused and its recycling of tires, the protection device 10 is an environmentally friendly device.

Changes can be made in the above constructions without departing from the scope of the invention. It is intended that all matter contained in the above description or shown in the accompanying drawings shall be interpreted as illustrative and not in a limiting sense. For example, multiple protection devices 10 can be placed over the mouth 22 and/or grate 113 of the storm drain inlets 12 and 112. In addition, the protection device can seat around the periphery of the mouth 22 and/or grate 113 rather than directly over the mouth 22 and/or grate 113.

What is claimed is:

1. A protection device for a storm drain inlet, comprising:
a tubular geotextile sleeve sized to cover a mouth of the storm drain inlet;
a filter media contained within the sleeve, wherein the filter media comprises tire pieces sized to remove and trap sediment within the sleeve, while permitting runoff water to enter the storm drain inlet; and
a closure member secured to each end of the sleeve.

2. The protection device of claim 1, wherein the tires pieces are from about 0.125″ to about 1″.

3. The protection device of claim 1, wherein the filter media is sized to allow removal of sediment within the sleeve with a cleaning process.

4. The protection device of claim 1, the tubular geotextile sleeve comprising a synthetic polymer.

5. A method of filtering sediment from runoff water before entry into a storm drain, comprising:
providing a tubular geotextile sleeve sized to cover a mouth of the storm drain inlet, and having a filter media within the sleeve, the filter media being sized to remove and trap sediment within the sleeve, while permitting runoff water to enter the storm drain inlet, wherein the filter media comprises tire pieces;
seating the tubular geotextile sleeve over the mouth of the storm drain inlet;
allowing runoff water to pass through the tubular geotextile sleeve and the filter media and into the storm drain inlet; and
trapping sediment from the runoff water within the sleeve.

6. The method of claim 5, further comprising:
removing the tubular geotextile sleeve from the mouth of the storm drain inlet;
removing the sediment from the sleeve; and
reseating the tubular geotextile sleeve over the mouth of the storm drain inlet;
allowing additional runoff water to pass through the tubular geotextile sleeve and filter media and into the storm drain inlet; and
trapping additional sediment from the runoff water within the sleeve.

7. The method of claim 5, the tubular geotextile sleeve comprising a synthetic polymer.

8. The method of claim 5, further comprising, providing a closure member to secured an end of the tubular geotextile sleeve.
